(19) United States
(12) Patent Application Publication
(10) Pub. No.: US 2026/0227370 A1
(43) Pub. Date: Aug. 6, 2026

(54) ANNOTATION AND IDENTIFICATION OF METABOLITE DERIVATIVES

(71) Applicant: Donald Danforth Plant Science Center, St. Louis, MO (US)

(72) Inventor: Allen Hubbard, St. Louis, MO (US)

(21) Appl. No.: 19/154,080

(22) PCT Filed: Feb. 9, 2024
(86) PCT No.: PCT/US2024/015206

§ 371 Date: Aug. 6, 2025

(51) Int. Cl. G01N 30/72; G01N 30/02; G01N 30/86; G01N 30/88

(52) U.S. Cl. CPC G01N 30/7233; G01N 30/8696; G01N 30/88; G01N 2030/027

(57) ABSTRACT

Systems and methods for annotation and identification of metabolite derivatives are provided. A data file can be received from a liquid chromatograph-mass spectrometry instrument that has analyzed a sample of unknown compounds. The data in the data file can include a retention time and a mass-to-charge (m/z) signal intensity for each compound. A set of the unknown compounds can be group together based on associated retention times falling into a same retention time range. A plurality of different pairs within the group can be generated for analysis and comparison of mass, resulting in identification of a mass gap (e.g., difference in signal intensity). A concentration of mass gaps associated with a set of the pairs within the group can be determined to be indicative of a metabolite and a derivative, and the data file can be annotated to identify that the subset of pairs corresponds to the indicated metabolite and the derivative.

### CROSS-REFERENCE TO RELATED APPLICATIONS

This application claims priority from Provisional Application No. 63/444,829, filed Feb. 10, 2023, the entire contents of which are hereby incorporated by reference.

### GOVERNMENTAL RIGHTS

This invention was made with government support under DE-SC0023160 and DE-SC0018277 awarded by the Department of Energy. The government has certain rights in the invention.

### FIELD OF THE INVENTION

The present disclosure relates generally to metabolite annotation. More specifically, the present disclosure relates to annotating LC-MS data files to identify metabolite derivatives.

### BACKGROUND OF THE INVENTION

Chromatography-mass spectrometry (MS) combines chromatographic separation and mass spectrometric identification to analyze compounds in samples. Chromatographic-MS techniques are capable of detecting ions with high precision but also generate significant noise. Ionization in a mass spectrum instrument can lead to the formation of multiple adducts, fragments, and artifacts, complicating the analysis by producing more signals than the original compounds present. Adduct formation, a common phenomenon in LC-MS analysis, results in a diverse array of derivatives from a single metabolite, influenced by the ionization mode and the presence of various ionic species. The identification of these adducts and derivatives poses a challenge due to the unpredictability of their formation and the limitations of existing annotation software, which relies on known mass shifts and cannot recognize new, unexpected derivatives de novo. This complexity creates a situation where the precise characterization of metabolites and their derivatives is difficult, hindering the untargeted detection of unique metabolite signatures within the vast and intricate landscape of mass spectrometry data.

There is therefore a need for improved systems and methods for de novo identification and annotation of metabolite derivatives.

### SUMMARY OF THE INVENTION

One aspect of the present disclosure encompasses a method for identifying metabolites and metabolite derivatives in chromatography-mass spectrometry (MS) data files. The method comprises the steps of (a) receiving or having received an MS data file from a chromatography-MS instrument, wherein the data file comprises data points obtained from a sample analyzed by the chromatography-mass spectrometry instrument, and wherein each data point in the file comprises a retention time value and a mass-to-charge (m/z) value; (b) grouping data points into groups of data points based on retention times of the data points falling in a retention time range; and (c) calculating a mass gap for each pair of data points in a group of data points, wherein a mass gap comprises a value equal to the difference between the m/z values of a pair of data points. A concentration of a mass gap identifies a pair of a metabolite and a derivative of the metabolite or a pair of derivatives of the metabolite. In some embodiments, the chromatography is liquid chromatography.

In some embodiments, the method further comprising identifying derivatives of a metabolite based on the mass gap between the metabolite and its derivative. A derivative can comprise one or more of an adduct, a fragment, a salt, and an isotopologue of the indicated metabolite. The method can also further comprise identifying or having identified a retention time range likely to comprise a metabolite and its derivatives and grouping the data points comprising retention times falling in the identified retention time range.

In some embodiments, the method further comprises annotating the data file with information that identify which data point can be associated with a given metabolite and its derivatives. Annotating the data file can further comprise identifying a different metabolite and at least one corresponding derivative associated with a different group. In some embodiments, the method further comprises filtering the data file based on the annotation. Filtering the data files can further comprise excluding a derivative and identifying a set of different metabolites in the sample.

In some embodiments, the method further comprises identifying a biomarker in the sample based on the annotated data file. Identifying the biomarker can comprise collapsing data point intensity values associated with the at least one derivative with data point intensity values associated with the metabolite. In some embodiments, an amount of the collapsed data point intensity values is associated with the metabolite, and wherein identifying the biomarker is further based on the amount of the collapsed data point intensity values.

Another aspect of the instant disclosure encompasses a system for annotating and identifying metabolite derivatives in chromatography-MS data files. The system comprises a communication interface that receives an MS data file from a chromatography-MS instrument, wherein the data file comprises data points obtained from a sample analyzed by the chromatography-mass spectrometry instrument, and wherein each data point in the file comprises a retention time value and a mass-to-charge (m/z) value. The system also comprises a processor that executes instructions stored in memory, wherein the processor executes the instructions to: (a) group data points into groups of data points based on retention times of the data points falling in a retention time range; and (b) calculate a mass gap for each pair of data points in a group of data points, wherein a mass gap comprises a value equal to the difference between the m/z values of a pair of data points, and wherein a concentration of a mass gap identifies a pair of a metabolite and a derivative of the metabolite or a pair of derivatives of the metabolite.

In some embodiments, the processor further executes the instructions to annotate the data file with information that identify metabolites and which derivative can be associated with a given metabolite and its derivatives. A derivative can comprise one or more of an adducts, a fragment, a salt, and an isotopologue of the indicated metabolite.

Unknown compounds in the sample can be grouped into a plurality of groups, each group corresponding to a respective set of the unknown compounds each identified as having co-eluted based on a respective timestamp that falls into a same retention time range. In some embodiments, the processor further executes the instructions to identify a derivative based on the mass gap relative to the metabolite.

In some embodiments, the processor annotates the data file by identifying a different metabolite and a corresponding derivative associated with a different group. The processor can further execute the instructions to filter the data file based on the annotation. In some embodiments, filtering the data files further comprises excluding a derivative, and identifying a set of different compounds in the sample. The processor can further execute the instructions to identify a biomarker in the sample based on the annotated data file. Identifying the biomarker can comprise collapsing data point intensity values associated with at least one derivative with data point intensity values associated with the metabolite. In some embodiments, an amount of the collapsed data point intensity values is associated with the metabolite, and wherein identifying the biomarker is further based on the amount of the collapsed data point intensity values.

An additional aspect of the instant disclosure encompasses a non-transitory, computer-readable storage medium, having embodied thereon a program executable by a processor to perform a method for identifying metabolite derivatives in chromatography-mass spectrometry (MS) data. The method comprises (a) receiving or having received an MS data file from a chromatography-MS instrument, wherein the data file comprises data points obtained from a sample analyzed by the chromatography-mass spectrometry instrument, and wherein each data point in the file comprises a retention time value and a mass-to-charge (m/z) value; (b) grouping data points into groups of data points based on retention times of the data points falling in a retention time range; and (c) calculating a mass gap for each pair of data points in a group of data points, wherein a mass gap comprises a value equal to the difference between the m/z values of a pair of data points, wherein a concentration of a mass gap identifies a pair of a metabolite and a derivative of the metabolite or a pair of derivatives of the metabolite.

The method can further comprise annotating the data file with information that identify which data point intensity values can be associated with a given metabolite and its derivatives. A derivative can comprise one or more of an adduct, a fragment, a salt, and an isotopologue of the indicated metabolite.

In some embodiments, unknown compounds in the sample are grouped into a plurality of groups, each group corresponding to a respective set of the unknown compounds each identified as having co-eluted based on a respective timestamp that falls into a same retention time range.

In some embodiments, the method further comprises annotating the data file by identifying a different metabolite and at least one corresponding derivative associated with a different group.

The non-transitory, computer-readable storage medium can further comprise instructions executable to identify the at least one derivative based on the mass gap relative to the metabolite. In some embodiments, the method further comprises filtering the data file based on the annotation. Filtering the data files further can comprise excluding the at least one derivative, and identifying a set of different metabolites in the sample. In some embodiments, the method further comprises instructions executable to identify a biomarker in the sample based on the annotated data file. Identifying the biomarker can comprise collapsing data point intensity values associated with the at least one derivative with data point intensity values associated with the metabolite. In some embodiments, an amount of the collapsed data point intensity values is associated with the metabolite, and wherein identifying the biomarker is further based on the amount of the collapsed data point intensity values.

### BRIEF DESCRIPTION OF THE FIGURES

The following drawings form part of the present specification and are included to further demonstrate certain embodiments of the present disclosure. Certain embodiments can be better understood by reference to one or more of these drawings in combination with the detailed description of specific embodiments presented herein.

FIG. 1 illustrates an exemplary mass spectrometry dataset from a UPLC-MS run displaying three axes representing RT, m/z ratio, and intensity. Inset: An enlarged portion of the same human urine data file highlighting the sensitivity and detail in the small molecule features collected.

FIG. 2A illustrates a first exemplary base compound and associated derivatives that can arise in a sample that includes the base compound.

FIGS. 2A and 2B illustrates a second exemplary base compound and associated derivatives that can arise in a sample that includes the base compound.

FIG. 3 illustrates an exemplary mass spectrometry (MS) data captured within a specific retention time (RT) window.

FIG. 4 is a graph illustrating exemplary concentrations of different mass gaps among co-eluting pairs of compounds.

FIG. 5 is a graph illustrating exemplary frequency of different mass gaps associated with a metabolite and its isotopologue.

FIG. 6 is a diagram of an exemplary sample that includes a plurality of metabolites and related derivatives.

FIG. 7 is a flowchart illustrating an exemplary method for annotating and identification of metabolite derivatives.

FIG. 8 illustrates an example of a system for implementing certain aspects of the present technology.

### DETAILED DESCRIPTION

Embodiments of the present disclosure include systems and methods for identification of compounds and derivatives of the compounds in chromatography-mass spectrometry (MS) data files. The inventors devised methods that can determine that compounds are related as base compound and derivatives of the base compound. Importantly, methods of the instant disclosure can determine that compounds are related even if the base compound itself is unknown and the nature of the derivation is unknown.

Unlike currently existing annotation methods, the methods and systems described herein have several key technical advantages. The first advantage is lack of reliance on an a priori knowledge base (which may not be comprehensive or which may otherwise be unreliable), as unknown or unexpected adducts or derivatives can be identified without having to retrieve or otherwise reference predetermined data. Because such predetermined data are likely to be far from exhaustive, many adducts and derivatives that can be unique to the experimental set-up (i.e. conjugation with the specific solvent) can be excluded and otherwise fail to be detected as such. The inability to comprehensively identify all derivatives associated mass shifts de novo leaves the vast majority of mass features unannotated by such prior art approaches. Additionally, the approach described herein can be extended to analyze labeled chromatography-MS data, with the extra stipulation that adduct candidates used to generate mass shifts must have the same number of labeled carbons (in addition to co-eluting).

### I. Methods

One aspect of the instant disclosure encompasses a method for identifying compounds and derivatives of the compounds in chromatography-MS data files. The methods can identify base compounds and their derivatives by determining that a pair of co-eluting compounds are related as base compound and derivative of the base compound, or as a pair of derivatives of the base compounds. The methods can also comprehensively annotate data files with information that identify which data point intensity values can be associated with a given metabolite and its derivatives.

In short, a chromatography-MS data file can be received from a chromatography-mass spectrometry instrument that has analyzed a sample comprising compounds that can be unknown. Each data point in the data file generated by the instrument comprises a retention time value and a mass-to-charge (m/z) value. Data points in a retention time (RT) window (range, also referred to herein as scan) can be grouped together for further analysis. The RT window can comprise co-eluting compounds that can be related. Mass gaps are calculated for each pair of data point values in each group, wherein a mass gap is the difference in m/z value between a pair of data point values. The frequency of the calculated mass gaps is then analyzed, wherein a concentration of a certain mass gap value within the group can be determined to be indicative of a pair of compounds that are the base compound and a derivative of the base compound or a pair of derivatives of the base compound. The identified compounds and data file can further be annotated to identify the indicated compound and at least one derivative of the compound.

### (a) Base Compounds and Derivatives

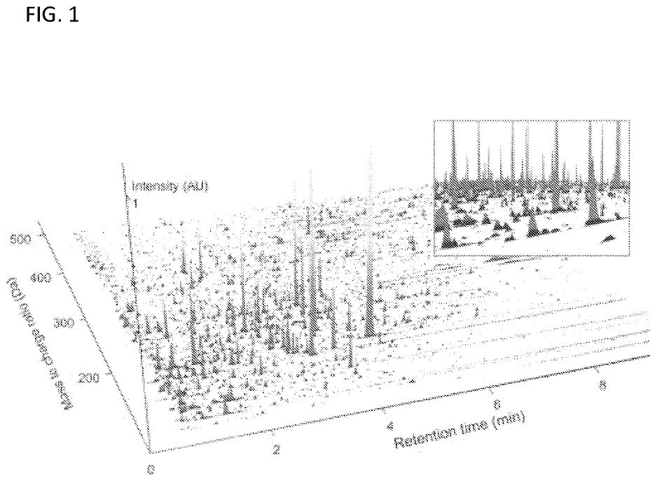

Chromatography-MS is a powerful analytical tool that combines the separation capabilities of chromatography with the detection and identification power of MS. Chromatography-MS comprises a first separation by chromatography where compounds with different properties separate and are collected at different times, leading to a separation of the constituents of the sample. The time point at which a certain fraction of a compound elutes from the column is called the retention time (RT). The resulting fractions are then inserted online into the mass spectrometer. Here the second separation takes place. By ionizing the compounds and accelerating them to fly through a field-free tube, the compounds are separated by their mass-to-charge (m/z) ratio (also referred to herein as “mass” for the sake of simplicity). Accordingly, a plurality of m/z signal intensities can be captured by a mass spectrometer in an output file, while intensity data records the abundance of a species of a given m/z relative to retention time. The measured data can then be depicted in a total ion chromatogram (TIC) 3D image comprising three axes. One axis depicts the RT, the second represents the m/z value, and the third axis represents the intensity or quantity of a peptide. The combined data of RT, m/z value, and intensity for each sample can be referred to as an LC/MS run. FIG. 1 shows an example 3D image of a UPLC-MS run from a sample comprising a plurality of metabolites, displaying three axes representing RT, m/z ratio, and intensity.

Methods of the instant disclosure comprise receiving or having received an MS data file from a chromatography-MS instrument. The data file comprises data points obtained from a sample analyzed by the chromatography-mass spectrometry instrument, wherein each data point in the file comprises the mass-to-charge (m/z) value and a retention time value.

In order to prepare a sample for entry into a mass spectrometer after separation by chromatography, the sample undergoes harsh ionization conditions, such as those created by electron spray ionization (ESI). These harsh ionization conditions can significantly alter molecules in an original fraction from a chromatography separation (base compounds), leading to the creation of various derivatives from the original base molecules. This process can result in adduct formation, fragmentation and creation of artifacts and other derivatives. The ionization can cause molecules to bind with other ions or molecules, creating adducts. Adducts are chemical derivatives of the original metabolites, which can include combinations with ions like sodium (Na+) or potassium (K+), altering the mass and charge of the compound. The ionization process can also break down the original molecules into smaller fragments. These fragments represent parts of the original molecule but with different mass-to-charge ratios. Besides adducts and fragments, ionization can lead to other types of chemical alterations, resulting in a range of derivatives. These derivatives may not directly represent the original compounds but are created as a result of the ionization process. Each type of derivative generated during ionization can produce unique signals (data points) in the mass spectrometer, which may give the impression that the sample contains a wider variety of compounds than it actually does. This complexity is due to the multiple ways in which a single compound can be altered, leading to a broad spectrum of mass features detected by the mass spectrometer.

The problem of formation derivatives is sufficiently widespread that the majority of mass features in a chromatography-MS run are conjectured to be derivatives of a base compound. Each base compound can generally form a dominant derivative depending on ionization mode (e.g., M-H for positive mode), in addition to potentially dozens of other species. These derivatives are often conjugates between a metabolite and a salt (e.g., Ca2+,Na+, Cl−, Br−) or other ionic species, fragments of a metabolite broken into functional groups (e.g., carboxylic acid), or combinations of metabolite fragments and ionic conjugations (e.g., salts).

While some common derivatives can be anticipated, formation of adducts or other derivatives are not entirely predictable. Thus, a sample analyzed by a chromatography-MS instrument can include data points associated with unexpected derivatives. Such derivatives cannot currently be identified by existing annotation software except through known mass shifts (e.g., gain of an Na+ atom), which are not comprehensive and therefore cannot identify previously unknown and unexpected mass shifts. That is because existing annotation software relies on already known or expected mass shifts and cannot identify unexpected compounds de novo.

Thousands of compounds co-elute in chromatography-MS analysis, many of which are not derivatives of a base compound. Further, the formation rules for even common adducts can be elusive and inconsistent across different experiments, especially for derivatives from fragmentation patterns, which may remain unidentified. Consequently, the array of possible derivatives from a sample is vast and challenging to fully characterize with pre-existing mass shifts that associate derivatives to their original base compound. Thus, although chromatography-MS aims to detect compound signatures, both as base compounds and their derivatives, in an untargeted manner, the intricate nature of mass spectrometry derivatives complicates the identification of unique compound signatures due to the multiplicity of derivatives a single compound can produce. This creates a paradox where data on potential adducts is essential for their annotation, yet the identification of these adducts is necessary to understand the data fully.

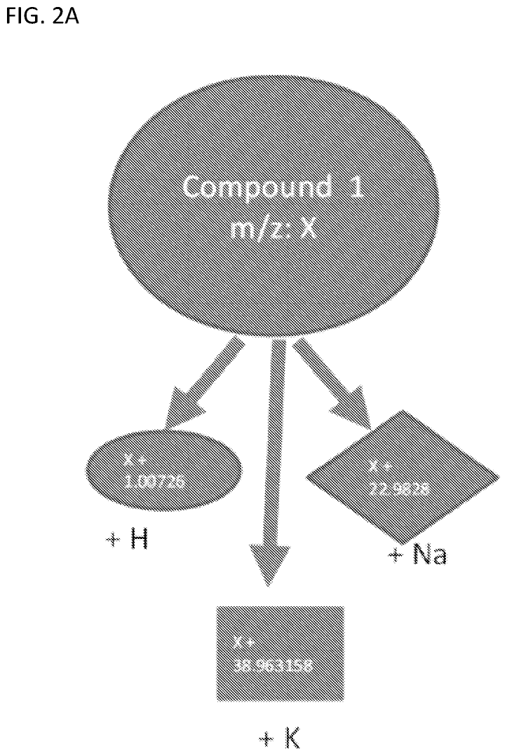

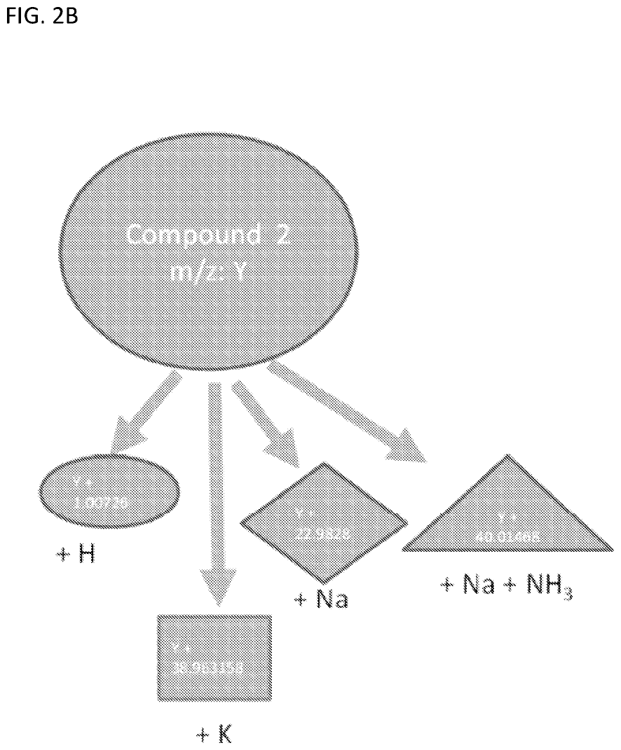

FIGS. 2A and 2B illustrate exemplary Compound 1 and Compound 2, respectively, and associated derivatives that can arise in a sample that includes the associated compound. Samples taken from, e.g., a living system, can comprise multiple unique compounds, each of which can further give rise to multiple different adducts, fragments, and other derivatives under the harsh conditions of ionization. Cumulatively, therefore, the resulting set of signals identified by an LC-MS instrument can indicate a much higher number of different molecules (e.g., metabolites plus associated adducts and fragments). As illustrated in FIG. 2A, Compound 1 can give rise to several adducts that differ based on respective association with different H, Na, or K ions. Meanwhile, FIG. 2B illustrates that Compound 2 can give rise to several adducts that differ based on respective association with different H, Na, K, or NA+NH3 ions. Thus, a sample that includes Compound 1 and Compound 2 can be analyzed by a chromatography-MS instrument to produce a data file of signals corresponding to their respective mass. Such a data file can not only include signals indicative of Compounds 1 and 2, but can further include signals indicative of their respective adducts as follows:

TABLE 1
m/z

Compound 1
Compound 1 + 1.00726
Compound 1 + 38.963158
Compound 1 + 22.98976928
Compound 2
Compound 2 + 1.00726
Compound 2 + 38.963158
Compound 2 + 22.98976928
Compound 2 + 40.01468328

### (b) Samples and Chromatography-MS

It will be recognized that methods of the instant disclosure can be used to identify compounds and related derivatives in data files obtained from a diverse range of samples, offering a broad scope for analysis and comparison. These data files can be obtained from a single sample, providing a detailed, focused examination of its components. Alternatively, the data files can be obtained from multiple samples collected independently, allowing for a comparative analysis across a wider range of variables. This versatility is particularly useful in experiments involving various treatments or conditions. For instance, samples from different treatment groups in a study can be analyzed to compare and contrast the effects of these treatments at a molecular level. Similarly, samples under different experimental conditions can provide insights into how these conditions influence the chemical composition of the samples.

Methods of the instant disclosure can be used to identify any compounds and derivatives of the compounds, including chemical, pharmaceutical, biochemical, and metabolomic compounds. Non-limiting examples of chemical, biochemical, and metabolomic compounds include biochemical compounds such as amino acids, peptides and proteins, nucleotides and nucleosides, DNA and RNA fragments, lipids (fatty acids, triglycerides, phospholipids, steroids), carbohydrates (monosaccharides, disaccharides, polysaccharides), vitamins, hormones, and enzymes; metabolomic compounds such as metabolic intermediates (glycolysis intermediates, Krebs cycle intermediates), neurotransmitters, plant metabolites (alkaloids, terpenes, flavonoids), bacterial and fungal metabolites, endogenous metabolites (bile acids, urea cycle intermediates), and xenobiotics (drugs, toxins); environmental contaminants such as pesticides and herbicides, polycyclic aromatic hydrocarbons (PAHs), persistent organic pollutants (POPs), and heavy metals and metalloids (in their organic forms); pharmaceuticals such as therapeutic drugs, drug metabolites, antibiotics; polymeric materials such as polymers and copolymers, additives and plasticizers, and oligomers; isotopically labeled compounds such as stable isotope labeled metabolites, deuterated compounds; industrial chemicals such as dyes and pigments, surfactants and detergents, and explosives; food and beverage analysis such as food additives, flavor compounds, contaminants; forensic analysis such as illicit drugs, explosive residues, and trace evidence compounds; and geological and cosmochemical analysis such as elemental isotopes, and organic molecules in extraterrestrial samples.

In some embodiments, Methods of the instant disclosure can be used to identify metabolites and derivatives of the metabolites. While specific types of compounds (e.g., metabolites such as fructose and galactose) can be discussed herein, such discussion of specific embodiments is for illustrative purposes and should not be interpreted as limiting the present disclosure to the specific embodiments being illustrated and discussed.

There are multiple categories of chromatography and MS, wherein each combination of chromatography and MS methods can cater to different analytical needs, depending on the complexity of the sample, the required sensitivity, resolution, and speed of analysis. The choice of technique is often determined by the specific application and the nature of the compounds being analyzed.

Non-limiting examples of major categories of chromatographic techniques that can be coupled with MS include Liquid Chromatography-Mass Spectrometry (LC-MS), Gas Chromatography-Mass Spectrometry (GC-MS), Ion Chromatography-Mass Spectrometry (IC-MS), Supercritical Fluid Chromatography-Mass Spectrometry (SFC-MS), Capillary Electrophoresis-Mass Spectrometry (CE-MS). Liquid chromatography methods can include High-Performance Liquid Chromatography (HPLC)—the most common form, utilizing high pressure to pass the sample through a column filled with stationary phase; Ultra-Performance Liquid Chromatography (UPLC)—similar to HPLC but uses smaller particle sizes in the column for higher resolution and faster analysis; Ion Exchange Chromatography—separates ions based on their affinity to an ion exchanger in the column; Size Exclusion Chromatography (SEC)—separates molecules based on size, using a column with pores of a specific size; Normal Phase Chromatography—uses a polar stationary phase and a non-polar mobile phase; Reverse Phase Chromatography—uses a non-polar stationary phase and a polar mobile phase, opposite to normal phase; Chiral Chromatography—separates enantiomers based on their interaction with a chiral stationary phase; Affinity Chromatography—uses a stationary phase made of materials that specifically bind to the analyte of interest. Gas chromatography methods include Capillary Gas Chromatography—uses very narrow capillary tubes with a liquid stationary phase; Packed Column Gas Chromatography—utilizes columns packed with solid stationary phase or solid support coated with liquid stationary phase; Gas-Solid Chromatography (GSC)—involves a solid stationary phase and is used primarily for separating gases or volatile compounds that don't interact with liquid stationary phases. Ion chromatography is typically used for the separation of ions and polar molecules. Supercritical Fluid Chromatography-Mass Spectrometry (SFC-MS) uses a supercritical fluid (like CO2) as the mobile phase, combining aspects of both GC and LC. It's particularly effective for analyzing compounds that are difficult to separate by traditional LC, such as chiral compounds. Capillary Electrophoresis: Although not technically a chromatographic technique, capillary electrophoresis separates ions based on their charge-to-size ratio in an electric field.

Non-limiting examples of MS include Quadrupole Mass Spectrometry (QMS)—uses quadrupole filters for mass analysis, suitable for a broad range of masses; Time-of-Flight Mass Spectrometry (TOF-MS); separates ions by their different flight times; Ion Trap Mass Spectrometry—traps ions using electromagnetic fields and then sequentially ejects them for mass analysis; Fourier Transform Ion Cyclotron Resonance (FT-ICR)—offers very high resolution and accuracy, using a magnetic field to trap ions; Orbitrap Mass Spectrometry—uses an electrostatic field to trap ions in an orbital motion around a central electrode; Triple Quadrupole Mass Spectrometry (QqQ) which incorporates three quadrupoles in series; commonly used for quantification due to its high sensitivity and specificity; Tandem Mass Spectrometry (MS/MS) which involves multiple stages of mass spectrometry, often with fragmentation of analyte ions between stages; Quadrupole Time-of-Flight Mass Spectrometry (Q-TOF) which combines quadrupole mass filtering with TOF mass analysis for high accuracy and resolution; and Magnetic Sector Mass Spectrometry which uses a magnetic field to deflect ions, with separation based on mass-to-charge ratio.

In some embodiments, methods of the instant disclosure can be used to overcome drift in retention times of LC-MS runs. In some embodiments, methods of the instant disclosure can be used to overcome drift in retention times of LC-MS runs for analyses of metabolites.

### (c) Mass Gaps

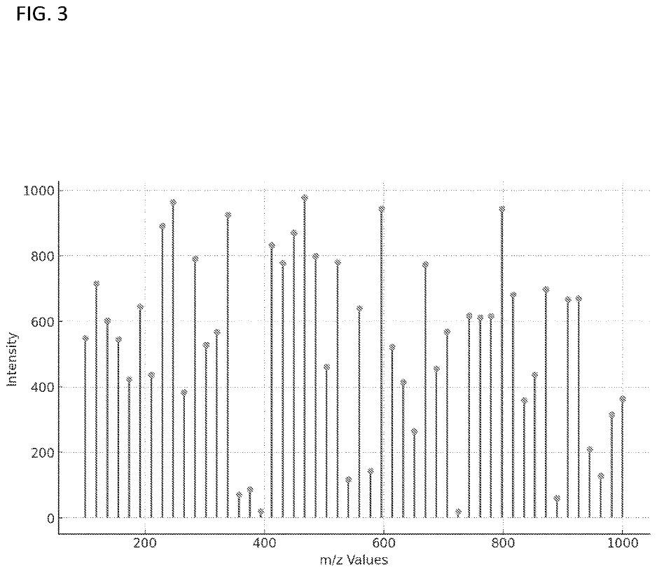

The inventors realized that, while the formation of metabolite adducts and other derivatives can be unpredictable, derivatives of the same species can share characteristics, such as retention times within a liquid chromatography column of the chromatography-MS instrument. Because adducts and other derivatives of a metabolite can be created during the electron spray ionization step, after chromatographic separation, the adducts or derivatives can occur in the same mass spectrometer RT window (scan) as the base compound. In particular, derivatives of the same base compound will co-elute within the same timeframe. FIG. 3 illustrates an exemplary mass spectrometry (MS) data captured within a specific RT window. It shows a range of m/z values, each with a corresponding intensity. These data points represent the various compounds that have been ionized and detected in this particular scan of the chromatographic analysis, reflecting the complexity of data that can be obtained during one time frame.

While a common retention time is insufficient by itself to identify that two different co-eluted compounds are related as base compound and adduct (or other derivative), the shared retention time can be used to identify when two compounds are not likely to be potential adducts or derivatives of each other. Moreover, the fact that adducts/derivatives of the same compound co-elute can further be used to substantially narrow the space of mass-features that can be related to one another as adducts. In other words, despite the unpredictable nature of compound derivative formation during the ionization process, such as with electron spray ionization (ESI), these entities tend to exhibit similar retention times to their parent compounds when analyzed through chromatography-MS. Consequently, both the base compounds elute from the column around the same time, enabling their detection within the same or closely aligned RT windows during the mass spectrometry analysis. This shared elution characteristic is key to associating derivatives with their parent compounds, even amidst the complex array of detected compounds.

Referring to the exemplary Compounds 1 and 2 discussed in relation to FIGS. 2A and 2B, associated adducts and derivatives can exhibit similar retention times as follows:

TABLE 2

| m/z | Retention Time (min) |
|---|---|
| Compound 1 + 1.00726 | 10.2 |
| Compound 1 + 38.963158 | 10.24 |
| Compound 1 + 22.98976928 | 10.25 |
| Compound 2 + 1.00726 | 8.2 |
| Compound 2 + 38.963158 | 8.3 |
| Compound 2 + 22.98976928 | 8.35 |
| Compound 2 + 40.01468328 | 8.33 |

As shown in Table 2, the derivatives of Compound 1 have similar retention times to each other (e.g., within 10-10.25 minute range), while the derivatives of Compound 2 likewise have similar retention times to each other (e.g., within 8-8.33 range). In exemplary implementations, the signals within a data file can be grouped together based on retention time, such that the signals in each group correspond to a compound and potential derivatives of the same compound. Because retention time can be captured for every compound in a sample (as indicated by a respective signal intensity measurement), such grouping can occur despite the base compound (e.g., Compound 1 or Compound 2) itself being unknown.

Once the data points have been classified or categorized into groups of co-eluting compounds (e.g., compounds having the same or similar retention times as indicated by respective timestamps), the respective data sets for each group can be examined to identify potential adducts or derivatives. To identify compounds in a group of data points, methods of the instant disclosure comprise calculating a mass gap between pairs of data points in a group. The term “mass gap” as used herein refers to a value equal to the difference between the m/z values of a pair of data points in a group.

Referring back to FIGS. 2A and 2B, it can be observed that within a set of compounds eluting together from a liquid chromatography column and detected by mass spectrometry, certain pairs of data points represent a unique relationship between a compound and its derivative, such as an adduct. These pairs are characterized by consistent mass gaps—specific differences in their mass-to-charge ratio (m/z) values, which can be attributed to common modifications like the addition of a hydrogen ion (e.g., +H). When analyzing data from co-eluting compounds, the recurring presence of these specific mass gaps across different pairs of data points indicates a meaningful relationship between the compounds involved, effectively defining the pair as a compound and its specific derivative. Thus, mass gaps that recur with higher frequency among co-eluting compounds stand out against the backdrop of other mass gaps, which appear sporadically and are considered background noise. This pattern of recurring mass gaps provides a basis for identifying and distinguishing between compounds and their derivatives within complex samples, where the consistent mass gap effectively marks the connection between a compound and its derivative.

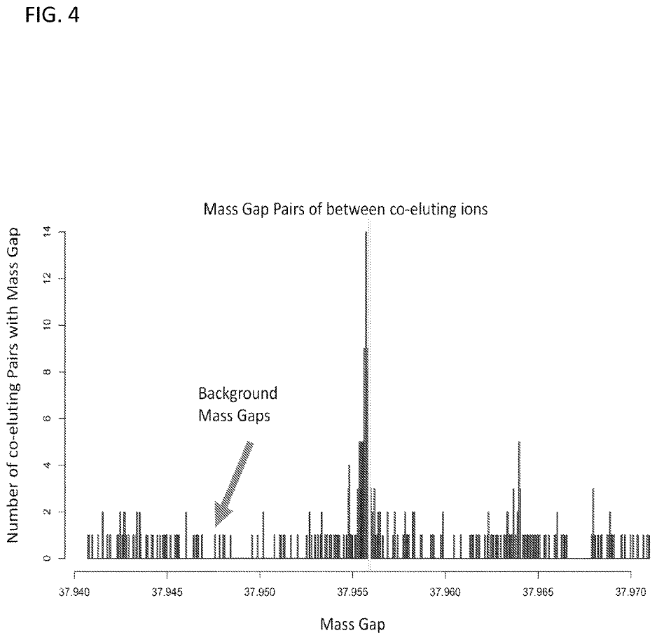

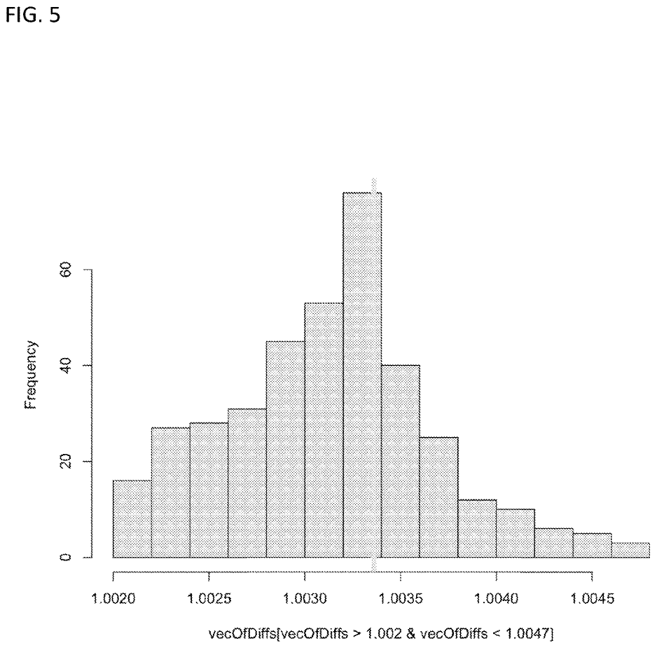

FIG. 4 is a graph illustrating exemplary concentrations of different mass gaps among co-eluting pairs of compounds within a group. As illustrated, the set of mass gaps (or mass shifts or mass differences) among pairs of co-eluting compounds can establish a baseline level of mass gaps. As further illustrated in the graph of FIG. 4, the distribution of mass gaps includes a particularly concentrated peak indicating a frequency that rises significantly above the baseline of background mass gaps. The distribution of mass gaps—and particularly the peak(s) identified therein—can be used to identify compounds that are adducts or other derivatives of the same metabolite. It will be recognized that the methods described herein also apply to identification of isotopologues of base compounds and isotopologues of derivatives of the base compounds. Isotopologues, although not technically derivatives of a compound, are structurally and chemically identical to the compound, except for the mass difference of a specific isotope atom and does not affect travel of the isotopologue in a chromatography column. Thus, data points in a chromatography-MS data file associated with an isotopologue of a compound are likely to comprise RT values within the RT-window of the compound. FIG. 5 is a graph illustrating exemplary frequency of different mass gaps associated with a metabolite and its isotopologue among co-eluting compounds within a group of coeluting compounds. Accordingly, a similar peak of a mass gap value can occur for isotopologues of a compound as illustrated in FIG. 5.

As methods of the instant disclosure can comprise grouping m/z values of data points falling into an RT range (scan), in some embodiments, a method of the instant disclosure comprises identifying or having identified a scan (RT window) likely to comprise a compound and its derivatives. Methods of selecting RT ranges of a scan likely to comprise one or more compounds are known in the art and include identifying a compound's peak in a fraction collected during the chromatographic run or anticipating a compound peak based on the compound's chromatographic behavior, including its expected retention time based on its physicochemical properties and the chromatographic conditions, such as column type, mobile phase composition, and flow rate. In some embodiments, the m/z value most likely to belong to a compound is identified using methods described in International Application No. PCT/US2022/028150, the disclosure of which is incorporated herein in its entirety.

The range of retention time increments of a scan can and will vary based on the distribution of obtained data values, the characteristics of the retention time profile, the shape and number of waveforms, the number of data points in a scan, and the desired level of precision for identifying compounds and derivatives. For instance, scans can comprise retention time increments of durations ranging from about 0.1 second or less to about 15 minutes or more, from about 1 second to about 10, 9, 8, 7, 6, 5, 4, 3, 2, 1 minutes or less, from about 1 second to about 50, 40, 30, 20, 10, 5 4, 3, or 2 seconds, or from about 30 seconds to about 1, 2, 3, 4, 5, 6, 7, 8, 9, 10, 11, 12, 13, 14, 15, 16, 17, 18, 19 or about 20 minutes or longer. Scans can also be categorized by the total number of scans desired in a chromatography-MS data file. For instance, a chromatography-MS data file can be divided into 10, 15, 20, 25, 30, 35, 40, 45, or about 50 or more scans. Furthermore, scans can be defined by the number of data points in each retention time increment of a scan. For instance, scans can be defined as a range of RT increments, wherein all RT increments can comprise the same number of data point values.

In exemplary implementations, key features can be extracted from a chromatography-MS data file generated by a chromatography-MS instrument, as well as mined, filtered, and analyzed to detect indicators of relationships between the different compounds. As noted above, the data file can be analyzed to identify signals (e.g., indicative of different compounds) associated with the same or similar retention times. Such (co-eluting) compounds can be grouped together and further analyzed in groups. Working with a pre-defined retention time window that defines a group of co-eluting compounds (e.g., several dozen to hundreds of scans), the mass difference between each co-eluting compound can be calculated. Different pairs of compounds within each group can be analyzed to identify a mass gap distribution within the group.

When plotted in such graphs as illustrated in FIG. 4 or FIG. 5, the distribution of the different mass gaps identified for pairs within the group can further be examined to determine whether there can be any concentrated peak(s), which can appear when a relatively high number of co-eluting pairs exhibit the same or similar mass gap in comparison to the other mass gaps within the group. In particular, the recurrence of adduct pairs (or pairs of other derivatives) can result in over representation within the mass gap distribution relative to pairs of unrelated compounds and can be identified as a peak.

For example, if Compounds A and B co-elute, a mass gap value abs(A_{m/z}−B_{m/z}) can be calculated. If Compounds A and B are not related to one another as base compound and its derivative or as two derivatives of the same base compound, the mass gap can be any random number, which is unlikely to align with the mass gap between other pairs of co-eluting compounds. However, if A is one type of adduct (e.g., M−H) and B is another type of adduct (e.g., M−K), the mass gap can correspond to the difference between K and H (approximately 38 Da). Because of the physics of mass spectrometry ionization, adduct patterns common to one mass feature can be common to many others. For example, if one mass feature forms M-H and M-K adducts, many other compounds can also produce the same types of adducts (i.e., M−H and M−K), which produces the same mass gap (38 Da). Even without knowing that M-H and M-K are common adduct patterns, the mass gap value of 38 occurs with a level of exceptional frequency (>100 times vs 4-5 times for a random mass gap) within the baseline distribution of all mass gaps among co-eluting compounds. It is highly likely, therefore, that any co-eluting compounds separated by 38 Daltons are adducts. This is because one sees a clear Gaussian around 38 Da rising out of a much lower background, when the frequency of mass gaps is plotted, which indicates that the statistical signature indicating an enriched mass gap is robust. In fact, any common set of adducts leaves a similar signature. Because each valid mass gap associated with an adduct pair will follow a Gaussian distribution centered around the true mass gap value when mass gap frequencies are plotted, all statistically enriched mass gaps can be identified. This makes it possible to compile a comprehensive list of all the possible mass gaps that show up with a frequency greater than chance among co-eluting compounds for use to comprehensively identify adducts and other derivatives of each compound in the sample. Importantly, such uses can further be generalizable to other LC-MS settings, which can even improve its performance. For example, in labeling experiments, mass gaps can be calculated not simply among co-eluting compounds, but among those that co-elute and show the same labeling pattern (as adducts will be identically labeled) in order to add a level of increased stringency.

### (d) Annotation

Using the collected information, a chromatography-MS data file can comprise a data structure that can be modified to add annotations that identify which signals can be associated with a given compound and its derivatives. Such annotations can be used to link compounds and their adducts and other derivatives to the parent ion in accordance with identified mass shifts. In particular, common derivatives can be associated with detectable signatures that can be amplified and isolated so as to comprehensively establish all valid mass shifts that relate adducts, fragments, etc., to parent ions. For example, certain adducts can be unique to a particular equipment and solvent configuration (and that could not be anticipated in manually pre-curated lists). In some implementations, therefore, more effective annotation of the degeneracies of the mass spectra can be achieved—without the limitations of a priori knowledge—in order to fully identify the landscape of adducts, fragmentation products, and other derivatives in a given sample. Such annotations can further pave the way for more complete identification and characterization of, e.g., unique metabolites in a living system than was previously possible. Referring to the example discussed above, the chromatography-MS data file for Compounds 1 and 2 can have identified distinct signal intensities and retention times for unknown adducts of Compounds 1 and 2. Based on the embodiment described herein, the data file can be updated to include annotations that identify the specific adduct.

TABLE 3

| | Retention | |
|---|---|---|
| | Time | |
| m/z | (min) | Annotation |
| Compound 1 + 1.00726 | 10.2 | [Compound 1 + H] |
| Compound 1 + 38.963158 | 10.24 | [Compound 1 + K] |
| Compound 1 + 22.98976928 | 10.25 | [Compound 1 + Na] |
| Compound 2 + 1.00726 | 8.2 | [Compound 2 + H] |
| Compound 2 + 38.963158 | 8.3 | [Compound 2 + K] |
| Compound 2 + 22.98976928 | 8.35 | [Compound 2 + Na] |
| Compound 2 + 40.01468328 | 8.33 | [Compound 2 + Na + NH3] |

While Table 3 only reflects annotations for two compounds (Compound 1 and Compound 2), the method can further be applied to any number of distinct compounds and their respective adducts in a given sample. Thereafter, the data regarding each compound can be examined in conjunction with data regarding its respective adducts or other derivatives in accordance with the annotation for a more detailed and granular picture of what is present in the sample. Such examination can also occur in a more organized and structured manner in light of the annotation, however, due to the annotation of heretofore unknown or unexpected adducts and derivatives as being related to a given compound.

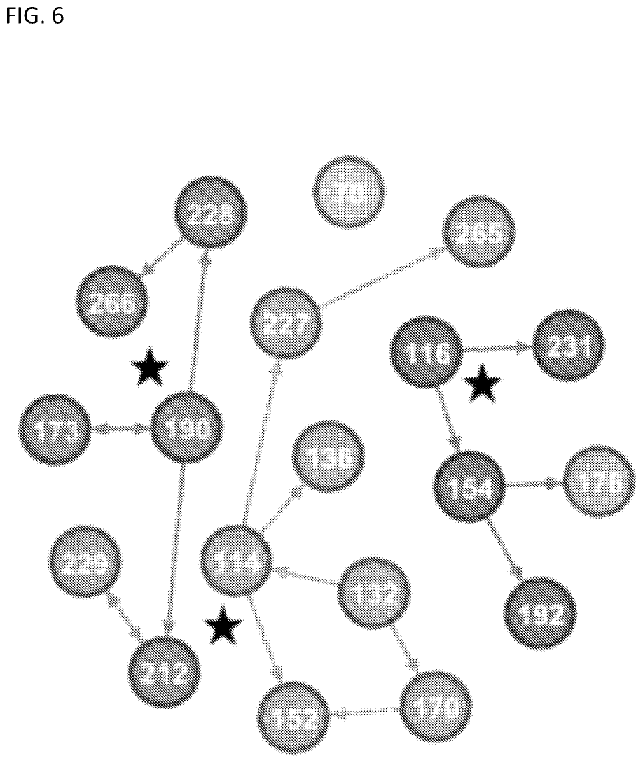

FIG. 6 is a diagram of an exemplary sample that includes a plurality of different metabolites and their respective derivatives. As illustrated, the sample of FIG. 6 can include nineteen different compounds each exhibiting a different m/z signal intensity value. The connected groups (each indicated by a star) can each include a set of compounds that have co-eluted as identified based on exhibiting the same or similar retention times within a chromatography column of a chromatography-MS instrument. The connections within a group can be confirmed in accordance with the mass gap analyses illustrated above, as well as annotated to identify the derivative type and relationship to a particular metabolite. The data file for the compounds illustrated in FIG. 6 can be annotated as follows:

TABLE 4

| m/z | analyte | annotation |
|---|---|---|
| 116.0711 | L-Proline | [M + H]⁺ |
| 154.0264 | L-Proline | [M + K]⁺ |
| 176.0100 | L-Proline | [M + Na + K—H]⁺ |
| 191.9822 | L-Proline | [M + 2K—H]⁺ |
| 231.1337 | L-Proline | [2M + H]⁺ |
| 173.0922 | homocitrulline | [M + H—NH₃]⁺ |
| 190.1195 | homocitrulline | [M + H]⁺ |
| 212.1005 | homocitrulline | [M + Na]⁺ |
| 228.0753 | homocitrulline | [M + K]⁺ |
| 229.1306 | homocitrulline | [M + Na + NH₃]⁺ |
| 266.0302 | homocitrulline | [M + 2K—H]⁺ |
| 114.0674 | creatine | [M + H—H₂O]⁺ |
| 132.0767 | creatine | [M + H]⁺ |
| 136.0476 | creatine | [M + Na—H₂O]⁺ |
| 152.0219 | creatine | [M + K—H₂O]⁺ |
| 170.0322 | creatine | [M + K]⁺ |
| 227.1255 | creatine | [2M + H—H₂O]⁺ |
| 265.0808 | creatine | [2M + H]⁺ |

Once the derivatives of a given compound are identified in the annotated data file, the derivative data can thereafter be processed in accordance with the annotation. For example, the data file can be filtered based on the annotation to exclude derivatives and identify unique compounds (e.g., metabolites) in the sample. Additionally, the annotations can be used to collapse or combine data sets regarding a compound with data sets regarding its derivatives so as to allow for examination of related data sets in conjunction with each other. In some implementations, the annotations can further be used to identify biomarkers, for clinical screening, pesticide development, and other processes and applications of chromatography-MS data files.

### (e) Embodiments

In some embodiments, a method of the instant disclosure can be used to identifying metabolites and metabolite derivatives in chromatography-mass spectrometry (MS) data files. In some embodiments, the chromatography-MS data files are obtained using a liquid chromatography-MS instrument (LC-MS).

The method can comprise receiving or having received an MS data file from a chromatography-MS instrument, wherein the data file comprises data points obtained from a sample analyzed by the chromatography-mass spectrometry instrument, and wherein each data point in the file comprises a retention time value and a mass-to-charge (m/z) value; grouping data points into groups of data points based on retention times of the data points falling in a retention time range; and calculating a mass gap for each pair of data points in a group of data points, wherein a mass gap comprises a value equal to the difference between the m/z values of a pair of data points. A concentration of a mass gap identifies a pair of a metabolite and a derivative of the metabolite or a pair of derivatives of the metabolite.

In some embodiments, the methods can further comprise identifying derivatives of a metabolite based on the mass gap between the metabolite and its derivative. A derivative can comprise one or more of an adduct, a fragment, a salt, and an isotopologue of the indicated metabolite.

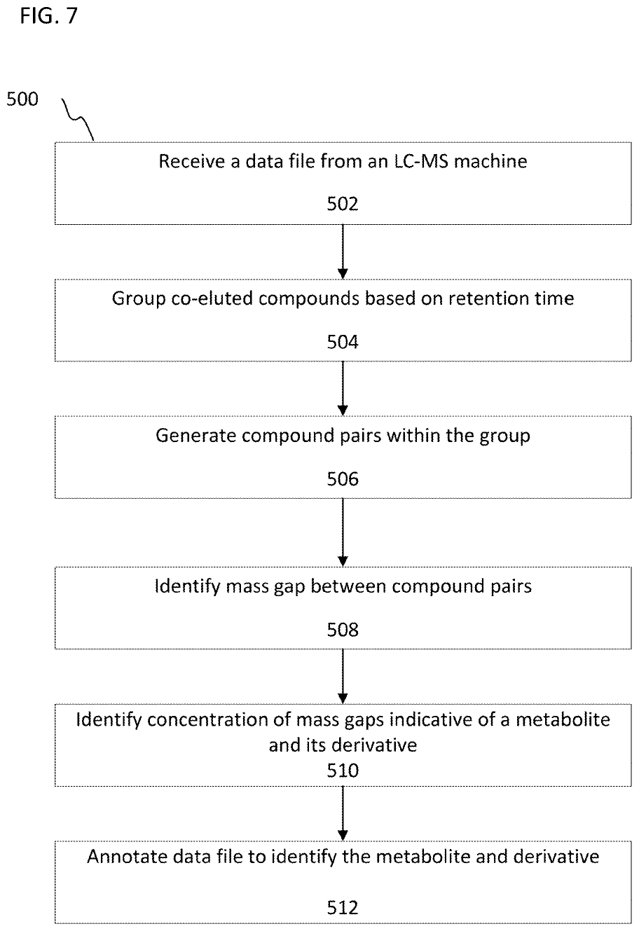

FIG. 7 is a flowchart illustrating an exemplary method 500 for annotating and identification of metabolite derivatives. The method 500 of FIG. 7 can be embodied as executable instructions in a non-transitory computer readable storage medium including but not limited to a CD, DVD, or non-volatile memory such as a hard drive. The instructions of the storage medium can be executed by a processor (or processors) to cause various hardware components of a computing device hosting or otherwise accessing the storage medium to effectuate the method. The steps identified in FIG. 7 (and the order thereof) are exemplary and can include various alternatives, equivalents, or derivations thereof including but not limited to the order of execution of the same.

In method 500, a data file containing m/z signal intensities and retention times can be captured by a liquid chromatography-mass spectrometry instrument that has analyzed a given sample. The m/z signal intensities in the data file can correspond to a respective mass measurement of one of the compounds in the sample, each of which can further be associated with a respective retention time. Co-eluted compounds having retention times falling into a common time window can be grouped together for further analysis, which can further comprise generating compound pairs and identifying mass gaps between such compound pairs. The distribution of mass gaps can be analyzed to identify the presence of one or more concentrated peaks of mass gaps, which can follow a specified statistical distribution and determined to be indicative of a metabolite derivative (e.g., adduct, isotopologue) of a metabolite. The data file can further be annotated to correlate each mass gap peak to a respective metabolite and identify that the compound associated with the mass gap peak is a derivative of the metabolite.

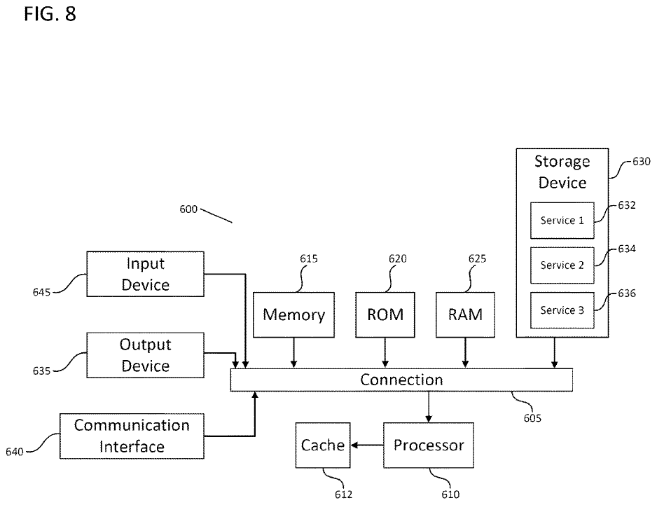

In step 502, a data file of data captured and measured in a sample by an LC-MS instrument can be provided to a computing system (described in further detail in relation to FIG. 8). Such a data file can be communicated to the computing system using any of a variety of interfaces known in the art for communicating information (e.g., liquid chromatography-mass spectrometry datasets) captured by an LC-MS instrument to the computing device for analysis. Each data file can include data regarding m/z signal intensities of signals associated with different mass measurements of compounds in a sample and can also contain the retention time or other chromatographic data information associated with each signal. In addition to chromatography, different separation techniques (e.g., electrophoresis, ion mobility, etc.) can also be used in conjunction with mass spectrometry to analyze isotopic patterns.

In step 504, the data regarding the different compounds of a given sample can be broken out into different groups based on retention time windows. As discussed herein, such compounds falling into the same retention time window or range can be co-elutes. The data regarding the co-eluted compounds of a given group can therefore be extracted and examined separately from other groups. Such groups can include one or more distinct metabolites, as well as each metabolite's derivatives.

In step 506, different compounds within the group can be paired for further analysis. Specifically, mass gaps can be identified for different compound pairs, and the distribution of the mass gaps present within pairs of a group can be examined for peaks above an established baseline. Such peaks can correspond to a specified distribution, such as a Gaussian distribution.

In step 510, one or more concentrations of mass gap can be identified that are indicative of a metabolite derivative. That is because mass gaps that are indicative of particular adduct types can tend to concentrate and appear as a peak within a plotted distribution of mass gaps. Thus, peaks corresponding to a Gaussian distribution can be a valid indicator of the presence of a particular adduct or derivative type.

In step 512, the data file regarding the sample can be annotated to identify data points that are correlated to each other as metabolite and derivatives thereof. The annotated data file can thereafter be provided to one or more recipient systems for further applications and uses. The annotated data file itself can be presented within a graphical user interface for use by different users. In other implementations, the annotated data file can further be filtered, collapsed, modelled, or otherwise applied inter alia to identify biomarkers, used in clinical screening, etc.

### II. System and Computer-Readable Storage Medium

Other aspects of the instant disclosure encompass a system for identifying compounds and compound derivatives in chromatography-mass spectrometry (MS) data files. The system comprises a communication interface that receives an MS data file from a chromatography-MS instrument, wherein the data file comprises data points obtained from a sample analyzed by the chromatography-mass spectrometry instrument, and wherein each data point in the file comprises a retention time value and a mass-to-charge (m/z) value. The system further comprises a processor that executes instructions stored in memory. The processor executes the instructions to group data points into groups of data points based on retention times of the data points falling in a retention time range; and calculate a mass gap for each pair of data points in a group of data points, wherein a mass gap comprises a value equal to the difference between the m/z values of a pair of data points, and wherein a concentration of a mass gap identifies a pair of a compound and a derivative of the compound or a pair of derivatives of the compound. In some embodiments, the compound is a metabolite.

In some embodiments, the processor further executes the instructions to annotate the data file with information that identify compounds and which derivative can be associated with a given compound and its derivatives. The derivative can comprise one or more of an adduct, a fragment, a salt, and an isotopologue of the indicated compound. In some embodiments, unknown compounds in the sample are grouped into a plurality of groups, each group corresponding to a respective set of the unknown compounds each identified as having co-eluted based on a respective timestamp that falls into a same retention time range. In some embodiments, the processor further executes the instructions to identify a derivative based on the mass gap relative to the base compound.

The processor can annotate the data file by identifying a different compound and a corresponding derivative associated with a different group. In some embodiments, the processor further executes the instructions to filter the data file based on the annotation. Filtering the data files can further comprise excluding a derivative and identifying a set of different compounds in the sample.

In some embodiments the chromatography-MS data file is obtained for a biological sample. In some embodiments, the processor further executes the instructions to identify a biomarker in the sample based on the annotated data file. Identifying the biomarker can comprise collapsing data point intensity values associated with at least one derivative with data point intensity values associated with the compound. An amount of the collapsed data point intensity values can be associated with the compound, and identifying the biomarker can be further based on the amount of the collapsed data point intensity values.

FIG. 8 illustrates an example of computing system 600 in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments computing system 600 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read only memory (ROM) and random access memory (RAM) to processor 610. Computing system 600 can include a cache of high-speed memory connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 can essentially be a completely self-contained computing system, containing multiple cores or processors, a bus, memory controller, cache, etc. A multi-core processor can be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement and therefore the basic features here can easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances the present technology can be presented as including individual functional blocks including functional blocks comprising devices, device components, steps or routines in a method embodied in software, or combinations of hardware and software.

Any of the steps, operations, functions, or processes described herein can be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions can be, for example, binaries, intermediate format instructions such as assembly language, firmware, or source code. Examples of computer-readable media that can be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter can have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

### Definitions

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them unless specified otherwise.

When introducing elements of the present disclosure or the preferred aspects(s) thereof, the articles “a”, “an”, “the” and “said” are intended to mean that there are one or more of the elements. The terms “comprising”, “including” and “having” are intended to be inclusive and mean that there may be additional elements other than the listed elements.

As used herein, the term “base compound” refers to an original, intact molecule as present in a sample to be analyzed by the chromatography-MS instrument, before introduction into the MS instrument for analysis.

As various changes could be made in the above-described cells and methods without departing from the scope of the invention, it is intended that all matter contained in the above description and in the examples given below, shall be interpreted as illustrative and not in a limiting sense.

What is claimed is:

1. A method for identifying metabolites and metabolite derivatives in chromatography-mass spectrometry (MS) data files, the method comprising:
a. receiving or having received an MS data file from a chromatography-MS instrument, wherein the data file comprises data points obtained from a sample analyzed by the chromatography-mass spectrometry instrument, and wherein each data point in the file comprises a retention time value and a mass-to-charge (m/z) value;
b. grouping data points into groups of data points based on retention times of the data points falling in a retention time range; and
c. calculating a mass gap for each pair of data points in a group of data points, wherein a mass gap comprises a value equal to the difference between the m/z values of a pair of data points;
wherein a concentration of a mass gap identifies a pair of a metabolite and a derivative of the metabolite or a pair of derivatives of the metabolite.

2. The method of claim 1, wherein chromatography is liquid chromatography.

3. The method of claim 1 or claim 2, further comprising identifying derivatives of a metabolite based on the mass gap between the metabolite and its derivative.

4. The method of any one of the preceding claims, wherein a derivative comprises one or more of an adduct, a fragment, a salt, and an isotopologue of the indicated metabolite.

5. The method of any one of the preceding claims, further comprising identifying or having identified a retention time range likely to comprise a metabolite and its derivatives and grouping the data points comprising retention times falling in the identified retention time range.

6. The method of any one of the preceding claims, further comprising annotating the data file with information that identify which data point can be associated with a given metabolite and its derivatives.

7. The method of claim 6, wherein annotating the data file further comprises identifying a different metabolite and at least one corresponding derivative associated with a different group.

8. The method of claim 7, further comprising filtering the data file based on the annotation.

9. The method of claim 8, wherein filtering the data files further comprises excluding a derivative and identifying a set of different metabolites in the sample.

10. The method of any one of the preceding claims, further comprising identifying a biomarker in the sample based on the annotated data file.

11. The method of claim 10, wherein identifying the biomarker comprises collapsing data point intensity values associated with the at least one derivative with data point intensity values associated with the metabolite.

12. The method of claim 11, wherein an amount of the collapsed data point intensity values is associated with the metabolite, and wherein identifying the biomarker is further based on the amount of the collapsed data point intensity values.

13. A system for annotating and identifying metabolite derivatives in chromatography-MS data files, the system comprising:
a. a communication interface that receives an MS data file from a chromatography-MS instrument, wherein the data file comprises data points obtained from a sample analyzed by the chromatography-mass spectrometry instrument, and wherein each data point in the file comprises a retention time value and a mass-to-charge (m/z) value; and
b. a processor that executes instructions stored in memory, wherein the processor executes the instructions to:
i. group data points into groups of data points based on retention times of the data points falling in a retention time range; and
ii. calculate a mass gap for each pair of data points in a group of data points, wherein a mass gap comprises a value equal to the difference between the m/z values of a pair of data points, and wherein a concentration of a mass gap identifies a pair of a metabolite and a derivative of the metabolite or a pair of derivatives of the metabolite.

14. The system of claim 13, wherein the processor further executes the instructions to annotate the data file with information that identify metabolites and which derivative can be associated with a given metabolite and its derivatives.

15. The system of claim 13 or claim 14, wherein the derivative comprises one or more of an adduct, a fragment, a salt, and an isotopologue of the indicated metabolite.

16. The system of any one of the preceding claims, wherein unknown compounds in the sample are grouped into a plurality of groups, each group corresponding to a respective set of the unknown compounds each identified as having co-eluted based on a respective timestamp that falls into a same retention time range.

17. The system of any one of the preceding claims, wherein the processor further executes the instructions to identify a derivative based on the mass gap relative to the metabolite.

18. The system of any one of the preceding claims, wherein the processor annotates the data file by identifying a different metabolite and a corresponding derivative associated with a different group.

19. The system of claim 18, the processor further executes the instructions to filter the data file based on the annotation.

20. The system of claim 18 or claim 19, wherein filtering the data files further comprises excluding a derivative, and identifying a set of different compounds in the sample.

21. The system of one of claims 18-20, the processor further executes the instructions to identify a biomarker in the sample based on the annotated data file.

22. The system of one of claims 18-21, wherein identifying the biomarker comprises collapsing data point intensity values associated with at least one derivative with data point intensity values associated with the metabolite.

23. The system of one of claims 18-22, wherein an amount of the collapsed data point intensity values is associated with the metabolite, and wherein identifying the biomarker is further based on the amount of the collapsed data point intensity values.

24. A non-transitory, computer-readable storage medium, having embodied thereon a program executable by a processor to perform a method for identifying metabolite derivatives in chromatography-mass spectrometry (MS) data, the method comprising:
a. receiving or having received an MS data file from a chromatography-MS instrument, wherein the data file comprises data points obtained from a sample analyzed by the chromatography-mass spectrometry instrument, and wherein each data point in the file comprises a retention time value and a mass-to-charge (m/z) value;
b. grouping data points into groups of data points based on retention times of the data points falling in a retention time range; and
c. calculating a mass gap for each pair of data points in a group of data points, wherein a mass gap comprises a value equal to the difference between the m/z values of a pair of data points, wherein a concentration of a mass gap identifies a pair of a metabolite and a derivative of the metabolite or a pair of derivatives of the metabolite.

25. The non-transitory, computer-readable storage medium of claim 24, wherein the method further comprises annotating the data file with information that identify which data point intensity values can be associated with a given metabolite and its derivatives.

26. The non-transitory, computer-readable storage medium of claim 24 or claim 25, wherein a derivative comprises one or more of an adducts, a fragment, a salt, and an isotopologue of the indicated metabolite.

27. The non-transitory, computer-readable storage medium of any one of the preceding claims, wherein unknown compounds in the sample are grouped into a plurality of groups, each group corresponding to a respective set of the unknown compounds each identified as having co-eluted based on a respective timestamp that falls into a same retention time range.

28. The non-transitory, computer-readable storage medium of any one of the preceding claims, wherein the method further comprises annotating the data file by identifying a different metabolite and at least one corresponding derivative associated with a different group.

29. The non-transitory, computer-readable storage medium of claim 28, further comprising instructions executable to identify the at least one derivative based on the mass gap relative to the metabolite.

30. The non-transitory, computer-readable storage medium of claim 28 or claim 29, further comprising filtering the data file based on the annotation.

31. The non-transitory, computer-readable storage medium of one of claims 28-30, wherein filtering the data files further comprises excluding the at least one derivative, and identifying a set of different metabolites in the sample.

32. The non-transitory, computer-readable storage medium of one of claims 28-31, further comprising instructions executable to identify a biomarker in the sample based on the annotated data file.

33. The non-transitory, computer-readable storage medium of one of claims 28-32, wherein identifying the biomarker comprises collapsing data point intensity values associated with the at least one derivative with data point intensity values associated with the metabolite.

34. The non-transitory, computer-readable storage medium of one of claims 28-33, wherein an amount of the collapsed data point intensity values is associated with the metabolite, and wherein identifying the biomarker is further based on the amount of the collapsed data point intensity values.
